(19) United States
(12) Patent Application Publication
(10) Pub. No.: US 2009/0212968 A1
(43) Pub. Date: Aug. 27, 2009

(54) Remote control units for mechanized toys

(75) Inventors: William Willett, Irvine, CA (US); Nicholas Amireh, Los Angeles, CA (US); Christopher J. Hardouin, Los Angeles, CA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Mattel, Inc., El Segundo, CA (US)

(21) Appl. No.: 12/378,711

(22) Filed: Feb. 17, 2009

Related U.S. Application Data
(63) Continuation of application No. PCT/US09/34084, filed on Feb. 13, 2009.
(60) Provisional application No. 61/029,135, filed on Feb. 15, 2008.
(60) Provisional application No. 61/088,366, filed on Aug. 13, 2008.

(51) Int. Cl. G05B 19/02

(52) U.S. Cl. 340/825.22

(57) ABSTRACT

A hand carried and operated remote control unit includes a housing configured as an other toy so as to support independent user play activity without a remotely controlled toy and including a main housing portion and at least a first handle extending outwardly and away from the main housing portion. A central vertical plane through front, rear, top and bottom sides of the housing divides the housing into two substantially equal halves. Circuitry in the housing includes a wireless signal transmitter, a controller and at least a tilt sensor connected in a subcircuit with the controller. The tilt sensor includes a ball tube with a central axis and a ball to roll along the tube between opposing ends of the ball tube to make or break the subcircuit. The central axis is pitched downwardly at an acute angle of at least twenty degrees with respect to a horizontal plane perpendicular to the central vertical plane and tangent to the bottom side of the main housing portion to provide a dead zone of the tilt sensor equal to or greater than the magnitude of the acute angle.

### CROSS REFERENCE TO RELATED APPLICATIONS

This application claims the benefit of priority of U.S. Provisional Application No. 61/029,135, filed Feb. 15, 2008, entitled “Manually Operated Remote Control Unit” and U.S. Provisional Application No. 61/088,366 filed Aug. 13, 2008, entitled “Manually Operated Remote Control Unit”, and is a continuation of International Application No.: PCT/US09/34084 filed Feb. 13, 2009, entitled “Remote Control Units for Mechanized Toys” the contents of which are incorporated herein by reference in their entirety.

### FIELD OF THE INVENTION

The invention relates to toy play sets including a mechanized toy with a wireless signal receiver so as to be remotely controlled and a remote control unit configured to be hand carried and manually operated including a wireless signal transmitter compatible with the wireless signal receiver for wireless remote control of the mechanized toy.

The wireless remote control units typically provided with a remotely controlled mechanized toys are configured for convenient and intuitive operation by a user but otherwise are unrelated in appearance or function to the toy being remotely controlled. As such, the remote control unit has no intrinsic play value by itself and does not encourage play by the user without the remotely controlled toy.

### SUMMARY OF THE INVENTION

The present invention is directed to improvements in toy play sets including a mechanized toy with a wireless signal receiver so as to be remotely controlled. According to the invention, a remote control unit configured to be hand carried and to remotely control a mechanized toy with wireless signal receiver comprises: a housing externally configured as an other mechanical toy so as to support user play activity without the mechanized toy, the housing further including a main housing portion and at least a first elongated handle extending longitudinally outwardly and away from the main housing portion, the other toy and the housing having a front side to face away from a user holding the remote control unit by all elongated handles provided on the remote control unit, a rear side to face away from the front side and towards the user holding all elongated handles provided on the main housing portion, a bottom side between the front and rear sides to face downward and a top side between the front and rear sides to face upward and away from the bottom side, a central vertical plane extended though the front, rear, top and bottom sides dividing the housing into two substantially equal, substantially mirror image halves; circuitry in the housing including the wireless signal transmitter and a controller operably connected to the wireless signal transmitter and configured to generate and transmit control signals to the mechanized toy in response to inputs from a user holding and operating the remote control unit; and at least a first tilt sensor located in the housing connected in a subcircuit with the controller, the first tilt sensor including an elongated ball tube with a central longitudinal axis and a ball having a diameter less than an inner diameter of the ball tube to permit the ball to roll along the tube between opposing ends of the ball tube so as to make or break the subcircuit, the central longitudinal axis of each ball tube being pitched downwardly at an acute angle having a magnitude of at least twenty degrees with respect to a horizontal plane perpendicular to the central vertical plane and tangent to the bottom side of the main housing portion to provide a dead zone of the tilt sensor equal to or greater than the magnitude of the acute angle.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 is a perspective view of a first embodiment tilt sensor equipped, hand carried, manually operated remote control unit of the present invention in a first handle bar configuration;

FIGS. 2A, 2B, 2C show tilt control operation of the handle bar remote control unit of FIG. 1;

FIG. 3 is a simplified block diagram of the electrical components of the unit of FIG. 3;

FIG. 4 is a simplified, exemplary bottom plan view of the control components of the unit;

FIG. 5 is a rear elevation view of the two tilt sensors of FIGS. 3 and 4 along the lines 5-5 in FIG. 4;

FIG. 6 is an exploded view of one tilt sensor;

FIG. 7 simplified, exemplary top plan view of components of a second embodiment tilt sensor equipped, hand carried, manually operated, remote control unit of the present invention in a second handle bar configuration;

FIG. 8 is a side elevation view along the lines 8-8 in FIG. 7 of a tilt sensor in the unit of FIG. 7;

FIG. 9 illustrates tilt control operation of the unit of FIGS. 7-8;

FIG. 10 is an elevation view of the right side of a third embodiment tilt sensor equipped, hand carried, manually operated, remote control unit of the present invention in a ray gun configuration;

FIG. 11 is a perspective view like FIG. 10 but with the right lateral side of the housing removed;

FIG. 12 is a simplified block diagram of the electrical components of the unit of FIG. 10;

FIG. 13 is a partially broken away, rear elevation view of the unit of FIGS. 10-11 depicting the provision of two second embodiment tilt sensors; and

FIG. 14 is an sectioned view of part of a third embodiment tilt sensor.

### DETAILED DESCRIPTION OF THE INVENTION

As state above, the present invention is directed to toy play sets including a mechanized toy configured with a wireless signal receiver and other components so as to be remotely controlled and a remote control unit configured to be hand carried and manually operated and including a wireless signal transmitter compatible with the wireless signal receiver for wireless remote control of the mechanized toy.

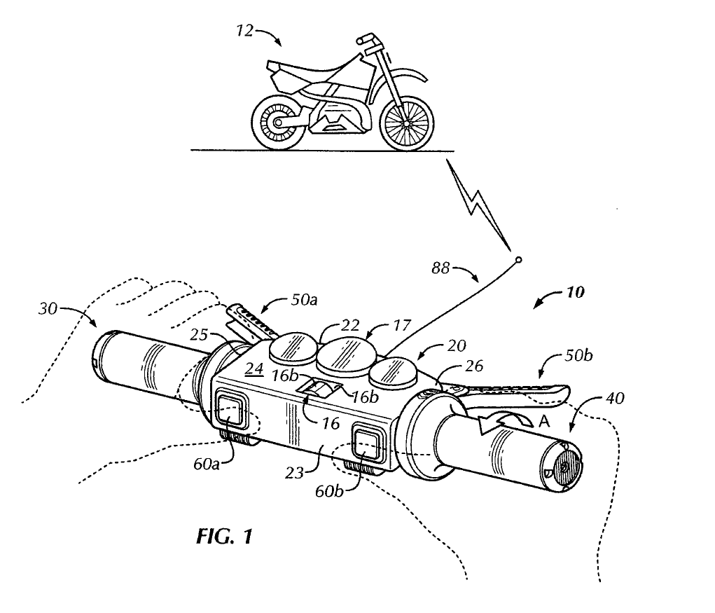

One such remote control unit 10 is depicted in FIG. 1 with a remotely controlled mechanized toy 12, a toy vehicle, in particular, a toy motorcycle, remotely controlled by the unit 10. The remotely controlled motorcycle 12 is entirely conventional including its own wireless signal receiver, controller, actuator(s) and power supply. The unit 10 includes a housing 14. The unit 10 is externally configured through the configuration of the housing 14 as an other mechanical toy so as to support or otherwise provide or encourage user play activity beyond or in addition to remote control of the mechanized toy. In other words, the unit 10 is configured as a separate toy with which the user can play without use or involvement of the mechanized toy 12. Preferably, the unit 10 and housing 14 can be provided in a shape and appearance that bear some relation to the mechanized toy 12 being controlled, whether it be in function or theme (appearance). In particular, the housing 14 of unit 10 is preferably shaped to resemble a pair of short or stub handlebars of a racing or stunt type cycle, to encourage the user to imagine steering the remotely controlled mechanized toy motorcycle 12 during use with the remotely controlled toy 12 or to imagine riding on and/or steering a motorcycle even without the toy motorcycle 12 being present or involved in the play action.

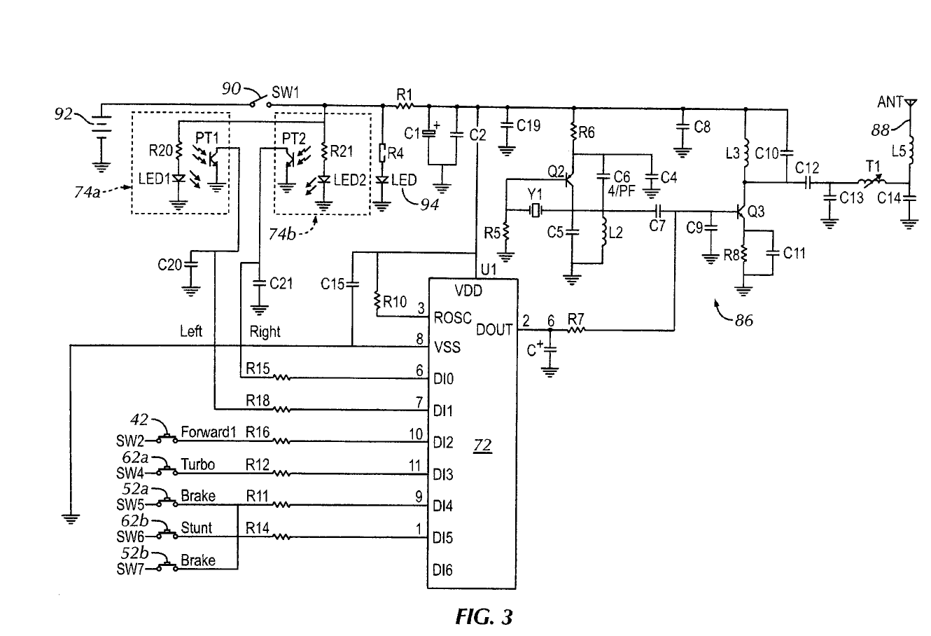

According to the invention, the housing 14 of unit 10 includes a main housing portion 20 preferably containing all or at least the bulk of the circuitry and preferably a battery power supply 92 (FIG. 3) to power the unit 10. Further according to the invention, the housing 20 of unit 10 further includes at least a first elongated handle 30 extending longitudinally outwardly and away from the main housing portion 20 of the housing 14. Unit 10 further includes a second elongated handle 40 extending longitudinally outwardly and away from the main housing portion 20 and away from the first handle 30.

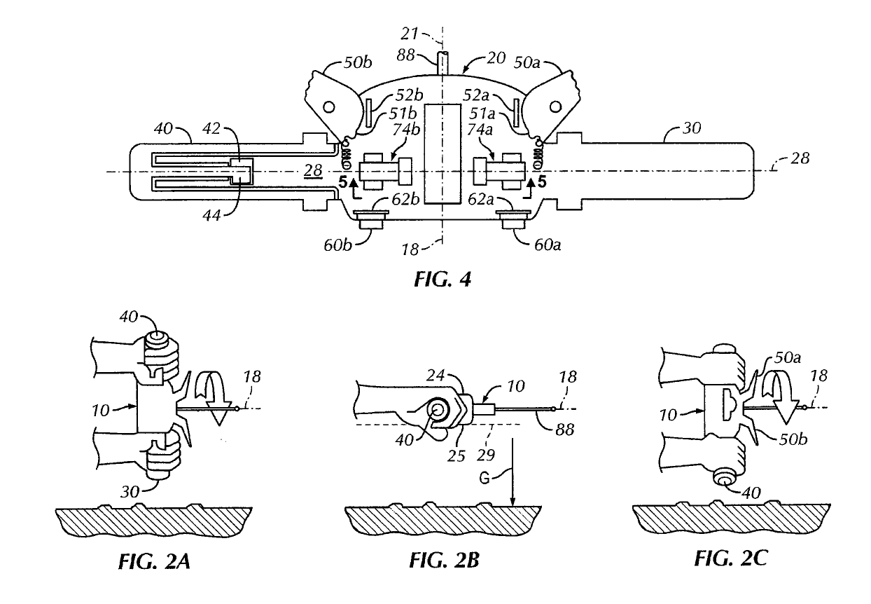

The unit 10 and main housing portion 20 have sides indicated in various FIGS. 1-3: a front side 22 to face away from a user holding the unit 10 by all of its provided elongated handles 30, 40 as shown in FIGS. 2A-2C, a rear side 23 to face away from the front side and towards the user holding the handles, a bottom side 25 between the front and rear sides 22, 23 to face downward and a top side 24 between the front and rear sides 22, 23 to face upward and away from the bottom side 25, a left lateral side 26 and a right lateral side 27. Thus, handle 30 is a left handle 30 extending longitudinally outwardly and away from the left lateral side 26 of the main housing portion 20 while handle 40 is a right handle extending longitudinally outwardly and away from the right lateral side 27 of the main housing portion 20 and away from the left handle 30. Since in this embodiment, the main housing portion 20 is located at least generally symmetrically between two handles 30, 40, it is also a central portion of the housing and may be referred to as the central housing portion 20 hereinafter. Referring to FIGS. 1 and 4, unit 10 and housing 14 have a central vertical plane 21 extending through the front 22, rear 23, top 24 and bottom 25 sides. Central vertical plane 21 divides housing 14 and the main housing portion 20 into two substantially equal and preferably substantially mirror image halves while it separates the first and second handles 30, 40.

The pair of handles 30, 40 may be a single assembly passed through or partially covered by main housing portion 20 or, as is the case with unit 10, the main housing portion 20 itself provides the only mechanical connection between the first and second handles 30, 40. Either or both handles 30, 40, can be fixed to the main housing portion 20 or rotatably connected with the main housing portion 20. In the depicted unit 10, the first (left) handle 30 is preferably integrally formed with the central housing portion 20. The second (right) handle 40 is preferably rotatably connected to the main housing portion 20 to rotate, preferably over only a limited angular range “A”, for example between about 20° and 60° and suggestedly about 30° to 45°, on a stub shaft 48 also preferably integrally formed with main housing portion 20, to mimic the operation of a real motorcycle throttle control. However, the first (left) handle 30 could be rotatably mounted in the same way instead of or in addition to the second handle 40.

If desired, one or more hand operated control levers or simply “hand levers” 50 can be provided preferably mounted to the main housing portion 20 on the front side 22 extending longitudinally outwardly away from the main housing portion 20 proximal to yet spaced from the first or second handle 30, 40, respectively, generally in line with the first or second handle, 30, 40, respectively, so as to be graspable by a user together with the respective first or second handle 30, 40. Hand levers 50 mimic the hand operated control levers provided on motorcycles and other hand brake equipped bikes. The hand lever(s) 50 may be decorative or functional, fixed or pivotable. Preferably first and second identical or mirror image hand levers 50a, 50b are mounted to the main housing portion 20 for pivotal movement. If desired, other manually operated control actuators such as one or more push buttons 60 may be provided on the main housing portion 20, two identical push buttons 60a, 60b being shown in FIG. 1 exposed on the rear side 23 of the main housing portion 20, where they can be conveniently operated by the thumbs of a user holding the unit 10.

FIG. 3 depicts in block diagram form, the components of the circuitry of the unit 10 indicated generally at 70 located in housing 14 with all or substantially all of the circuitry 70 being located in the main housing portion 20. The components of circuitry 70 include a controller 72 preferably in the form of a microprocessor or similar functioning device, with the necessary programming to generate and transmit control signals to the toy 12 in response to various manual inputs from a user holding or operating the unit 20. Electrically connected in subcircuits with the controller 72 are a pair of mirror image tilt sensors 74 located in the main housing portion 20, preferably with a first tilt sensor 74a proximal the first or left handle 30 and second tilt sensor 74b proximal the second or right handle 40. A first pair of identical, pressure actuated, momentary contact switches 52 are preferably provided in the main housing portion 20 in subcircuits with the controller 72 and proximal the pivots of hand levers 50. In particular, switches 52a and 52b are positioned juxtaposed to the proximal ends of hand levers 50a, 50b, respectively, where they are in operable connection with and can be depressed and actuated by cams 51a, 51b on the proximal ends of the levers 50a, 50b. A second pair of identical, pressure actuated, momentary contact switches 62 are provided in the main housing portion 20 in subcircuits with the controller 72, switches 62a and 62b being positioned juxtaposed to push button-manual actuators 60a, 60b respectively, so that button-actuators 60a, 60b are in operable connection with the switches 62a, 62b, which are actuated by depression of those button-actuators 60a, 60b. Yet another pressure actuated, momentary contact switch 42 is provided in a subcircuit with the controller 72, preferably in or proximal to rotatable right handle 40, where it is positioned for actuation by rotational movement of the handle 40, in particular, to operably be depressed by a cam 44 carried on the handle 40 within the handle 40. It should be appreciated that the handles 30, 40 can be reversed in configuration so that the first or left handle 30 is mounted to the main housing portion for rotational movement and the switch 42 positioned for manual operation by the rotational movement of the first handle 30. For example, switch 42 can be used to manually command acceleration, switches 52a, 52b used to manually command braking, switches 62a, 62b used to generate other commands and sensors 74a, 74b used to manually command left/right steering of the remotely controlled toy vehicle 14.

In this embodiment, a battery power supply 92 is preferably provided in the main housing portion 20 electrically connected in a power supply circuit with the controller 72 and with a wireless signal transmitter indicated generally at 86, itself operably connected with the controller 72. The wireless signal transmitter 86 includes a modulator in the form of a transistor Q3 operably connected with a wireless signal transmitter element 88 in the form of a radio antenna projecting from the front wall 222 of main housing portion 220. Battery power supply 92 is further connected with the various switches 42, 52a, 52b, 62a, 62b through the controller 72. An on-off power switch 90 can be provided in the power supply circuit with or without a power indicating LED 94 or other light sources, if desired. Fewer or additional electrical components including switch(es), light source(s) and/or a sound source (none depicted) can be provided, if desired. The circuitry arrangement is exemplary; other arrangements can be used.

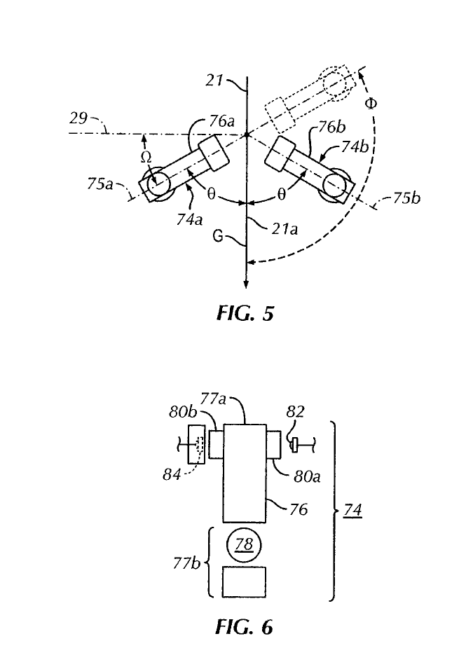

FIG. 4 depicts an exemplary plan bottom view of the interior layout of the control components of the unit 10 looking up from the bottom of the unit 10. FIG. 5 is a rear elevation view of just the first and second tilt sensors 74a, 74b of FIG. 4. Referring to FIG. 6, each tilt sensor 74 includes an elongated ball tube 76 with central longitudinal axis 75 and a ball 78 having a diameter less than an inner diameter of the tube 76 to permit the ball 78 to roll between opposing longitudinal ends 77a, 77b of the tube 76 so as to make a break the subcircuit with controller 72. The exact diametric difference between the tube 76 and ball 78 can be selected to control the acceleration of the ball 78 and thus the response of the tilt sensor 74. Referring to FIG. 6, at one longitudinal end 77a of the ball tube 76, on opposite sides of the ball tube 76, are positioned an LED or comparable light source 82 and a photodiode or comparable light responsive element 84 aimed at the light source 82. Preferably, light source 82 and light responsive element 84 can be positioned in stub tubes 80a, 80b perpendicular to the elongated ball tube but they maybe positioned in any other way desired. When the ball 78 is located at the first (stub tube) end 77a of the ball tube 76, it blocks light from the LED 82 to the photodiode 84 and breaks that subcircuit, which is sensed by the controller 72 as an open circuit. When the ball 78 moves away from the one longitudinal end 77a sufficiently for light from source 82 to strike light responsive element 84, the subcircuit is made, which is sensed by the controller 72 as a closed circuit. In the case of unit 10, the tilt sensor subcircuits are normally broken and open but the tilt sensors could be inverted from their indicated position so that the elements 82, 84 are located at the top of the sensors 76 and would be normally made and closed.

Referring to FIG. 4, the ball tubes 76 and their central longitudinal axes 75 are not parallel to one another. Ball tubes 76 and their central longitudinal axes 75 need not even be parallel to a common plane but preferably they are in unit 10, parallel to and defining in common a vertical transverse plane 28 extending perpendicular to central vertical plane 21 and with central vertical plane 21 in and out of FIG. 4. Preferably, the central longitudinal axes 75a, 75b of each ball tube 76a, 76b, respectively, lie in the vertical transverse plane 28 and each axis and tube is inclined with respect to the other axis and tube when viewed in front or rear elevation. Preferably each tube 76 and its central longitudinal axis 75 is pitched away from the lower portion 21a of the central vertical plane 21 extending below the tubes 76 through the bottom side 25 of the main housing portion 20 at an identical acute angle θ, suggestedly at least about ten, desirably twenty or more, preferably between about thirty to forty-five, less preferably up to sixty but no more than seventy degrees. Referring to FIGS. 2A-2C and 5, the unit 10 has to be rotated with respect to the gravity vector “G” until the central longitudinal axis 75a or 75b of one of the tubes 76a, 76b is pitched sufficiently in the vertical transverse plane 28 perpendicular to central vertical plane 21 (the plane of FIG. 5) with respect to the gravity vector “G” extending downwardly in the central vertical plane 21 between the tubes 76a, 76b at an obtuse angle Φ greater than ninety degrees, (exaggerated in phantom), so that the ball 78 normally residing at the first end 77a of one of the ball tubes 76a, 76b, moves away from that end to the opposing end 77b of that tube. This arrangement gives the unit 10 an angular dead zone of equal to or greater than 180 minus [2×θ] degrees with respect to the gravity vector “G” for rotation of the unit 10 from a nominal, tilt neutral position depicted in FIGS. 2B and 5 in the vertical transverse plane 28 perpendicular to the central vertical plane 21 (i.e. rotation in a plane parallel to the plane of FIG. 5). Each sensor contributes 90-θ degrees or more to the dead zone. It will be appreciated that other tilt sensors 74 can be provided in different orientations to signal or not signal controller 72 as desired.

Tilt steering operation of the unit 10 is depicted in FIGS. 2A-2C. The unit 10 is shown in FIG. 2B in a nominal, tilt neutral operating position with the main housing portion 20 and handles 30, 40 generally level and perpendicular to the gravity vector “G”. The manner in which the unit 10 is held in a tilt neutral operating position should be intuitive to any user old enough to remotely control the toy vehicle 12, as should the various sides 22-27 of the housing 14. The first and second handles 30, 40, configured with respect to the main housing portion 20 as a pair of handlebars, invite the user as shown in FIGS. 2A-2C to grab the handles 30, 40 in a way so as to face in generally downwardly directions away from the top side 22 of the housing 14, the palms to the user holding the first and second handles 30, 40 with both hands. The hand levers 50 would be recognized as being located on an apparent front side of the housing 14 as would the antenna 88. The apparent rear side 23 faces away from the apparent front side and toward the user and the buttons 60a, 60b are located on the rear side 23 proximal each of the handles 30, 40 to invite thumb operation. The top side 24 can be made apparent by the provision of functional or simulated elements such as other control buttons that could be reached and operated with the forefinger(s) of the user holding the unit 10 by handles 30, 40, or a tilt level display 16 or a simulated instrument cluster 17 normally found centered between the handles of real motorcycles. The tilt level display 16 need be nothing more than a bottom weighted cylinder 16a mounted in the main housing portion 20 to rotate on an axis perpendicular to the gravity vector “G” in the tilt neutral position of the unit 10 with surface indicia visible though a window 16b on the top side 25 of the main housing portion 20 indicating the degree of tilt and/or the amount of tilt necessary to change the state of a tilt sensor and thus provide a user command to the controller 72.

The bottom side 25 of the housing 14 would be devoid of such elements but might be expected to include a battery compartment cover as is the norm with conventional remote control transmitter units. The bottom side 25 preferably would also be sufficiently flat or at least level, as is the norm with conventional remote control transmitter units, to provide a base to stably support the unit 10 when it is not being held, preferably in a tilt neutral position. As is best seen in FIG. 2B, bottom side 25 is preferably sufficiently flat such that a horizontal plane 29 tangent to the bottom side 25 is perpendicular to the central vertical plane 21 and preferably perpendicular to the transverse vertical plane 28 to which both tilt sensors 74 and their central longitudinal axes 75 are parallel. In such a configuration, the tilt angle of the ball tubes 76 and their central longitudinal axes 75 can be measured downwardly from the horizontal plane 29 and would be the complement to angle θ, namely an acute angle Ω (see FIG. 5) with a magnitude of at least twenty degrees, desirably at least about thirty, more preferably between about forty-five and sixty degrees, less preferably up to seventy and suggestedly no more than about eighty degrees. The dead zone provided by each tilt sensor 74 from a tilt neutral operating position would then be about equal to the magnitude of the acute angle Ω.

To generate and transmit a left turn control signal from the unit 10, the unit 10 is rotated in the transverse vertical plane 28 perpendicular to the central vertical plane 21 of the unit 10, about an axis 18 in the central vertical plane 21 that is generally parallel to the horizontal plane 29 and nominally perpendicular to the gravity vector “G”, thereby elevating the right handle 40 while lowering the left handle 30 sufficiently to elevate the first end 77a above the second end 77b and cause the ball 78 of the right tilt sensor 74b to roll to the second end of ball tube 76b. This permits light from the source 82 to pass to the photodiode 84, thereby signaling the controller 72 that the right handle 40 and its tilt sensor 74b have been elevated sufficiently above the left right handle 30 and its tilt sensor 74a for the controller 72 to generate a left turn signal and transmit it wirelessly to the remotely controlled toy, vehicle 12. FIG. 2C depicts the opposite rotational configuration to cause a right turn signal to be generated. With the configuration of tilt sensors 74a, 74b in FIG. 5, neither tilt sensor 74a or 74b transmits a signal to the controller 72 when the unit 10 and bottom side 25 of main housing portion 20 are generally level and square to the gravity vector “G” with the bottom side 25 down. When one sensor 74a, 74b is raised sufficiently above the other, the state of the elevated tilt sensor and its subcircuit with the controller 72 will change signaling the controller 72 of the user command.

Note that if the unit 10 is inverted, both tilt sensors 74 will change states and the controller 72 is preferably programmed to recognize the inverted position. It may be further programmed to not transmit any control signals, to transmit a warning, for example, either flashing an LED (not depicted) provided on the bottom side of the unit 10 to provide a visual warning that the unit 10 is inverted and/or generating a sound warning if sound generation capability is provided.

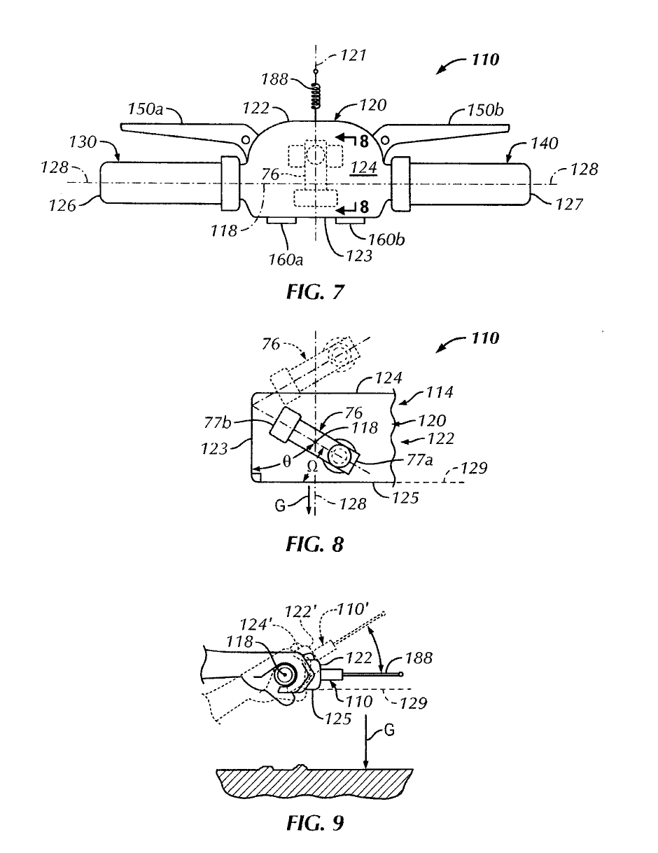

FIGS. 7-9 depict a second embodiment, tilt sensor equipped, hand carried, manually operated, wireless transmission, remote control unit of the present invention indicated generally at 110. Unit 110 is very similar to the first embodiment unit 10 including a housing 114 again shaped to resemble a pair of short stub handlebars of a racing or stunt type cycle, to encourage the user to imagine steering the remotely controlled mechanized toy motorcycle 12 (FIG. 1) during use with the remotely controlled toy 12 or to imagine riding on and/or steering a motorcycle even without the toy 12 being present or involved in the play action.

Again, housing 114 of unit 110 includes a main housing portion 120 preferably containing all or at least the bulk of the circuitry 70 of unit 10 and battery power supply 92 (FIG. 3) to power the unit 110. Further according to the invention, housing 114 includes at least a first elongated handle 130 extending longitudinally outwardly and away from the main housing portion 120 and a second elongated handle 140 extending longitudinally outwardly and away from the main housing portion 120 and away from the first handle 130. Again, the unit 110 and main housing portion 120 have sides indicated in various FIGS. 7 and 9: a front side 122 to face away from a user holding the unit 110 by all of its provided elongated handles 130, 140 as shown in FIG. 9, a rear side 123 to face away from the front side 122 and towards the user holding the handles 130, 140, a bottom side 125 between the front and rear sides 122, 123 to face downward and a top side 124 between the front and rear sides 122, 123 to face upward and away from the bottom side 125, a left lateral side 126 and a right lateral side 127. Again, a central vertical plane 121 extends through the various front, back, top, and bottom sides 122, 123, 124, 125 dividing the unit 110 and housing 114 and main housing portion 120 into two substantially equal and preferably two substantially mirror-image halves and separating handles 130 and 140. Again, hand levers 150a, 150b and/or push button, manually actuated control elements 60a, 60b can be provided for operator command inputs or, in the case of the hand levers 150, simply decoration. Again, the bottom side 125 of the main housing portion 120 is sufficiently flat to provide a stable base to support the unit in a tilt-neutral position when placed on a horizontal surface. A horizontal plane 129 tangent to the bottom side 125 is also perpendicular to the central vertical plane 121. Same angular range suggestions apply.

The significant difference between remote control units 10 and 110 is that unit 110 has but a first tilt control sensor 74 like that previously described with its ball tube 76. First tilt sensor 74 is oriented front and back in the main housing portion 120 of the unit 110 with its central longitudinal axis 75 extended towards front and rear sides 122, 123. As can be seen in FIG. 8, the first longitudinal end 77a of ball tube 76 is more proximal the front side 122 of the housing 114 and main housing portion 120 while the second longitudinal end 77b is more proximal the rear side 123. Preferably, the first end 77a is depressed below the second end 77b in the main housing portion 120. As a result, in order to activate the tilt sensor 74, the unit 110 has to be rotated about a transverse or lateral “pitch” axis 118, extending perpendicular to the central vertical plane 121 in a vertical transverse plane 128 bisecting the handles 130, 140 and perpendicular to the central vertical plane 121 and perpendicular to the horizontal plane 129 that is tangent to the bottom side 125, sufficiently to elevate the first end 77a above the second 77b with respect to the gravity vector G. In this configuration, the tilt sensor 74 could signal the unit's controller (72 in FIG. 3) to generate an appropriate control signal such as, but not limited to, an acceleration signal, for example a signal to shift to a higher gear for “turbo” acceleration, or a stunt signal, for example a signal which commands a toy vehicle remotely controlled by the unit to perform a “wheelie” in which the front wheel(s) elevates off a surface supporting the rear wheel(s). Other control switches (for example 42, 52, 62 in FIG. 3) can be provided for the user to manually enter commands to the controller (72 in FIG. 3) to generate an appropriate control signals to transmit to the remotely controlled toy 12. For example, levers 150a, 150b could be used to command braking and accelerating, respectively, with the push buttons 160a, 160b used to command left and right turns, respectively. Even the grips 130 or 140 can be made to rotate with respect to the housing 120 to generate a command. The particular commands and manual actuators used to enter those commands by the user may be varied as desired.

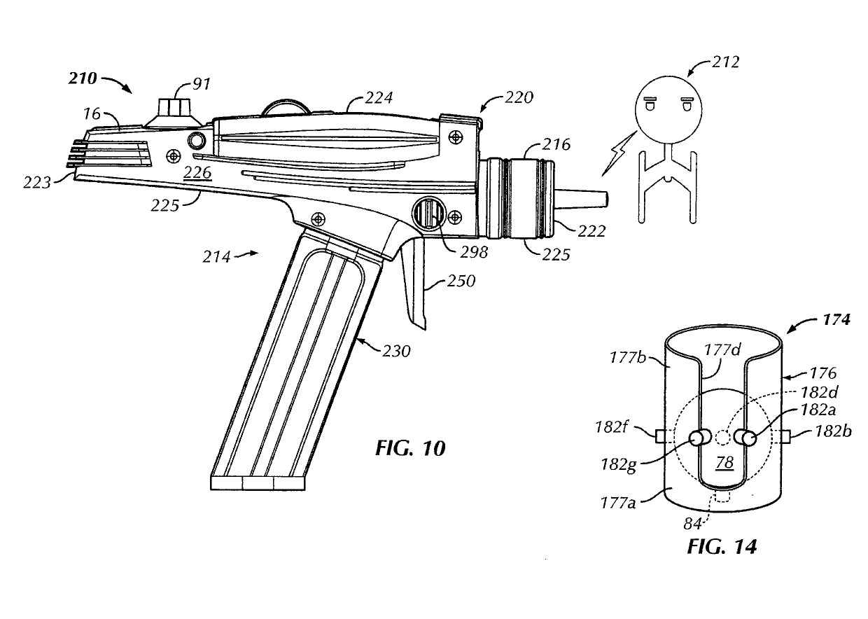

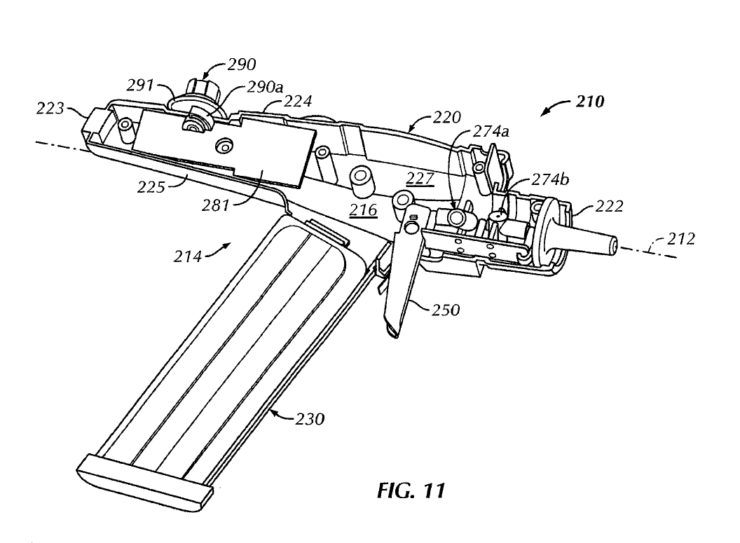

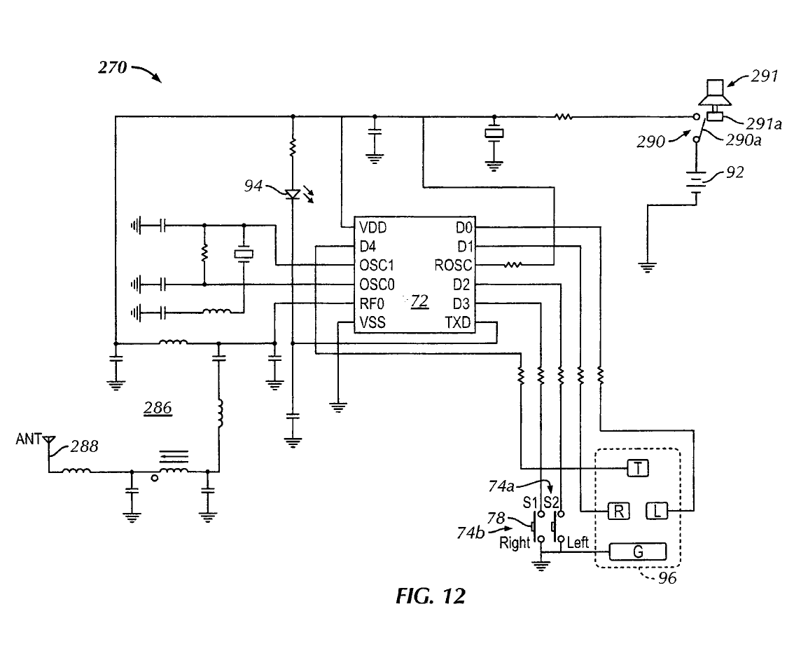

FIGS. 10 and 11 depict a third embodiment, tilt sensor equipped, hand carried, manually operated, wireless transmission, remote control unit of the present invention indicated generally at 210. Unit 210 is designed to control operation of a remotely controlled toy aircraft 212 configured as a “space” ship but provided with propellers for powered flight. Unit 210 is shaped to resemble a ray gun to support user play activity without the vehicle 212, but could be provided in other shapes. Unit 210 comprises a housing 214 with a main housing portion 220 containing the electronic circuitry 270 and a battery power supply 292 (see FIG. 12) to operate and power the unit 210. The housing 214 includes a first and only elongated handle 230 extending outwardly and away from the main housing portion 220. The unit 210 and housing 214 have various sides: front 222 (facing away from user), rear 223 (facing user), top 224, bottom 225 and right (lateral) side 226. The left (lateral) side 227, the inside of which is shown in FIG. 11, is preferably substantially a mirror image to the right side 226. Again, a central vertical plane 221 extends through the front, rear, top and bottom sides 222-225 of the unit 210, the housing 214, the main housing portion 220, and this time, through the first and only elongated handle 230 and divides the housing 214, main housing portion 220 and handle 230 into two substantially equal and preferably at least substantially mirror image halves. Preferably a horizontal plane 228 is defined by a tangent to a bottom side of the housing 214, preferably the main housing portion 220 but alternatively or additionally, the first handle 230.

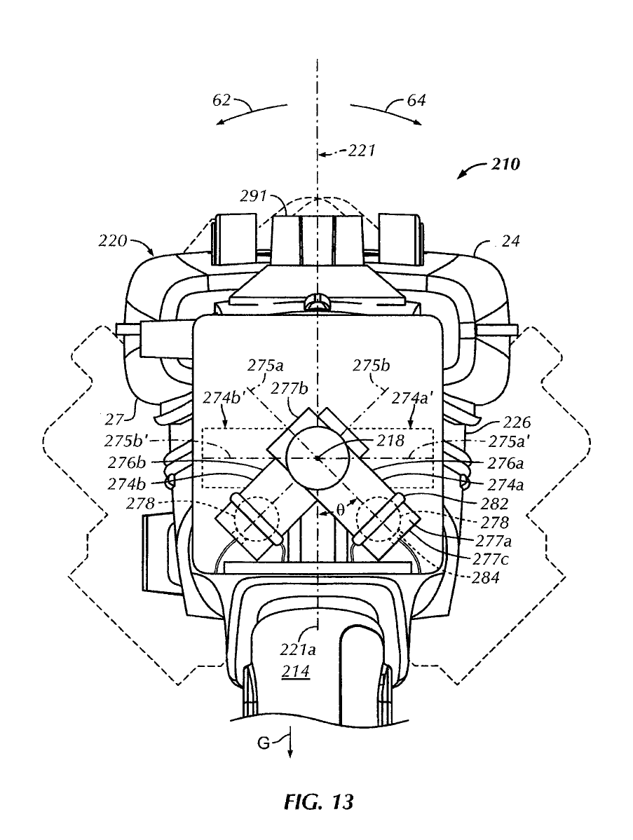

FIG. 12 depicts in block diagram form, the components of the circuitry suggested for the unit 210 and indicated generally at 270. The components are preferably mounted on a printed circuit board 281 (see FIG. 11) in the main housing portion 220. The circuitry 270 again includes a controller 272 like controller 72 in the form of a microprocessor or similar functioning element(s). Electrically connected with the controller 272 in separate subcircuits are a pair of mirror image tilt sensors 274 located in the main housing portion 220, a first tilt sensor 274a extending up and to the left and a second tilt sensor 274b extending up and to the right 240 when viewed from the rear 223 of the unit 210 (see FIG. 13). An on-off switch 290 (see FIGS. 11 and 13) has a dial actuator 291 with cam 291a, which opens or closes a pair of contacts 290 (see FIGS. 11 and 12). A throttle control circuit is also indicated generally at 296 in FIG. 12 and includes three logic input terminals: R, T and L and a ground terminal G. Each is preferably an electrically conductive pad. A rotary actuator 298 (FIG. 10) is provided carrying a wiper (not depicted) for the connection of different combinations of R, T, L with one another and G to signal the microprocessor 272 a desired speed. Five different speeds can be encoded with the throttle control circuit 296. If desired, a pressure actuated, momentary contact switch (not depicted) can be provided proximal the pivot of a trigger 250 where it can be depressed and actuated by a cam (not depicted) on the proximal end of the trigger 250. Other switches (not depicted) can be provided in the housing 220 for controlling auxiliary functions in the vehicle. In this unit 210, battery power supply 292 is preferably located in the handle 230 and is electrically connected in a power supply circuit with the controller 272, and through the controller 272 with the two tilt sensors 274a, 274b, respectively, the throttle control circuit 296 and a radio transmitter circuit indicated generally at 288 and including an antenna 289 radio signal transmission element. Battery power supply 292 may be further connected with the various switches through the microprocessor 272, if such switches are provided. On-off power switch 290 can be provided in the power supply circuit of battery 292 with or without a power indicating LED 294 or other light sources, if desired. Fewer or additional electrical components including fewer or additional switch(es), fewer or additional light source(s) and/or a sound source (none depicted) can be provided, if desired. The circuitry arrangement is entirely exemplary and different arrangements can be provided.

FIG. 13 is a rear elevation of the unit 210 showing the pair of second embodiment tilt sensors 274a, 274b of FIG. 12 in a tilt-neutral upright operating position. Referring to FIG. 13, each tilt sensor 274 includes a ball tube 276 and a ball 278 having a diameter less than the inner diameter of the tube 276 to permit the ball 78 to roll between opposing ends 277a, 277b of the tube 276. The exact diametric difference between the tube 276 and ball 278 can be selected to control the acceleration of the ball 278 and thus the response of the tilt sensor 274. At one end 277a of the tube 276 are positioned an electrically conductive ring 282 and, in an end wall 277c, an electrically conductive pin 284. The ball 278 is itself electrically conductive. The ring 282 is sized and positioned with respect to the pin 284 such that it is contacted by the ball 278 resting on the pin 284. When the ball 278 is located at the first end 277a of the ball tube 276, it electrically connects the ring 282 and the pin 284 and makes or closes a subcircuit with the microprocessor 72. In this way, the microprocessor 72 is signaled that the ball 278 is located at the first end 277a of the respective ball tube 276.

Referring to FIGS. 11 and 13, the ball tubes 276 and their central longitudinal axes 275 are not parallel to one another and are not even co-planar. Preferably, each is parallel to a transverse vertical plane 278, which extends perpendicularly to the central vertical plane 221 (and the plane of FIG. 13) and which is centered between the tilt sensors 274a, 274b. Each tube 276a, 276b has a central longitudinal axis 275a, 275b, respectively, that is inclined with respect to the other at least when viewed in front or rear elevation. For the right cylinder tubes 276 shown, preferably, each is pitched at an identical angle (θ) away from the central vertical plane 221 of the housing 214 extending front 222 to rear 223 (in and out of FIG. 13) and top 224 to bottom 225 (vertically in FIG. 13) through the housing 214 and main housing portion 220. Preferably each tube 76 is pitched away from the lower portion 221a of the central vertical plane 221 extending below the tubes 76 through the bottom 225 of the housing 220 at an identical acute angle θ, suggestedly at least about ten, desirably twenty or more, preferably between about thirty and forty-five, less preferably up to sixty but no more than seventy degrees to provide a dead zone of at least twenty degrees (90-θ).

Referring to FIG. 13, the unit 210 has to be rotated with respect to the gravity vector “G” until the first end 277a of one of the right cylinder tubes 276a or 276b is elevated at least to or above its second end 277b so that the ball 278 normally residing at the first end 277a of one of the ball tubes 276a, 276b, moves away from that end and at least towards the opposing, second end 277b of that tube.

Tilt steering operation of the unit 10 is depicted in FIG. 13 from the point of view of the user looking at the rear side 223 of the unit 210. The unit 210 is shown in solid in FIG. 13 in a tilt-neutral upright operating position with the main housing portion 220 generally level and perpendicular to the gravity vector “G”, and its central vertical plane 221 parallel to gravity vector “G”. To generate and transmit a left turn control signal from the unit 210, the unit 210 is rotated counter-clockwise (arrow 262) sufficiently relatively to an axis 218 extending in the central vertical plane 221 and longitudinally, front to rear, in and out of the plane of FIG. 13, to the position shown in phantom at 274a′ with central axis 275a′ about ninety degrees or more from the portion 221a of the central vertical plane 221 below the sensors 274 in the tilt neutral orientation of the unit 210, to cause the ball 278 of sensor 274a to roll away from the first end 277a and at least towards the second end 277b of tube 276a. The rotation has to be more than 90-θ degrees to upend the tube 276a. This breaks the subcircuit formerly existing between sensor 274a and the microprocessor 272, thereby signaling the microprocessor 272 that the unit 10 has been rotated sufficiently about its longitudinal axis 218 for the microprocessor 272 to generate a left turn signal and transmit it to a controlled toy, like a vehicle toy 212. An opposite (clockwise) rotation (arrow 264) causing sensor 274b to be rolled about the axis 218 at least the same amount (90-θ degrees or more) from the tilt-neutral position, at least to the position shown in phantom at 274b′, so that central axis 275b′ is about 90° or more from central vertical plane lower portion 221a and its ball 278 rolls away from its first end 277a toward its second end 277b and breaks the subcircuit of the second tilt sensor 274b with the controller 272 and signals the controller 272 of that change of orientation of unit 210. The controller 272 then generates and transmits a right turn signal to the controlled toy 212.

With the configuration of tilt sensors 274a, 274b in FIG. 13, each tilt sensor 274a, 274b makes a subcircuit with and thereby passes a signal to the controller 272 with the unit 210 in the tilt-neutral position generally level and square to the gravity vector “G” and the top side 224 up. Note that if the unit 210 is inverted, the subcircuits of the controller 272 with both tilt sensors 274 will be broken. Preferably the controller 272 is programmed or otherwise configured to recognize the inverted position. It may be programmed or configured to not transmit any control signals and/or to transmit a warning, for example, either lighting an LED on the bottom side of the unit (not depicted) to provide a visual warning that the unit is inverted and/or generating a sound warning if sound generation capability is provided.

While conductive ring 282 and pin 284 are described as being at the first, normally lower ends 277a of the sensor tubes 276, the invention includes locating them at the second, normally upper ends 277b. In this configuration with the unit 210 in the tilt-neutral upright operating position, shown in FIG. 13, the subcircuit between either sensor 274a, 274b and the controller 272 is broken (or open) in the tilt-neutral position so no signal is passed through either sensor 274a, 274b. It is only when the unit 210 is rolled sufficiently clockwise or counter-clockwise to move a ball 278 to the second end 277b of one of the sensors 274a, 274b, that a subcircuit with the controller 272 is made (or closed) so that a signal can pass through that sensor notifying the controller 272 of that change of orientation of the unit 210.

FIG. 14 depicts a third embodiment tilt sensor of the present invention indicated generally at 174 having a ball tube 176 with opposing longitudinal ends 177a, 177b. The ring 282 of the second embodiment sensor 274 is replaced by a plurality, circumferential pins suggestedly six to eight, 182a et seq., extended generally radially through the circumferential wall 177d of the ball tube 176, preferably with a uniform angular spacing between the pins 182a et seq., measured from the central longitudinal axis 175 of the ball tube 176. The circumferential pins 182a et seq. can all be connected together (i.e. in parallel) and the center pin 284 of the second embodiment sensor 274 retained so that when an electrically conductive ball 278 contacts any one of the circumferential pins 182a et seq. and the center pin 284, a subcircuit between the pins 182 and 284 is closed with the microprocessor 272 to signal the microprocessor 272 of the location of the ball 278. Alternatively, the center pin 284 can be deleted and alternate circumferential pins (i.e. 182a, 182c, 182e, etc.) electrically connected together in parallel in a first subcircuit leg and the remaining alternate circumferential pins (e.g. 182b, 182d, 182f, etc.) connected together in a separate subcircuit leg, so that when a conductive ball 78 contacts any two adjoining circumferential pins 182, the subcircuit circuit is again made and closed with the controller 272 to signal the controller 272 of the location of the ball 278.

Incorporated herein in their entireties are U.S. Pat. Nos. 6,095,891 and 7,234,990 describing wireless remotely controlled toy motorcycles with which remote control units 10, 110 might be paired and U.S. Patent Publication No.: 2007/0259595 and U.S. Pat. No. 5,087,000 disclosing remotely controlled flying vehicles that might be configured as “space” ships to be paired with unit 210.

Furthermore, while the sensors are described as being right cylinders, they need not be so. They could be curved so that the angles formed between a tangent at either longitudinal end of a tube and the central longitudinal vertical plane 21 are different from the angle formed with the same plane 21 by a straight line between the ends 77a, 77b of the tube. The dead zone would be controlled by the angle between the central vertical plane or the horizontal plane and a tangent to the lower end of the ball tube.

It will be appreciated by those skilled in the art that changes could be made to the embodiments described above without departing from the broad inventive concept thereof. For example, while the active electrical elements of the described tilt sensors have been positioned at the lower ends of the ball tubes, they could be located at the upper ends so that each tilt sensor operates in a reverse manner from the manner described for making or breaking the subcircuit. It is understood, therefore, that this invention is not limited to the particular embodiments disclosed, but it is intended to cover modifications within the spirit and scope of the present invention as defined by the appended claims.

We claim:

1. A remote control unit configured to be hand carried and to remotely control a mechanized toy with wireless signal receiver, the remote control unit comprising:
a housing externally configured as an other mechanical toy so as to support user play activity without the mechanized toy, the housing further including a main housing portion and at least a first elongated handle extending longitudinally outwardly and away from the main housing portion, the other toy and the housing having a front side to face away from a user holding the remote control unit by all elongated handles provided on the main housing portion, a rear side to face away from the front side and towards the user holding the handles, a bottom side between the front and rear sides to face downward and a top side between the front and rear sides to face upward and away from the bottom side, a central vertical plane extended though the front, rear, top and bottom sides dividing the unit and the housing into two substantially equal halves;
circuitry in the housing including a wireless signal transmitter and a controller operably connected to the wireless signal transmitter and configured to generate and transmit control signals to the mechanized toy in response to inputs from a user holding and operating the remote control unit; and
at least a first tilt sensor located in the housing connected in a subcircuit with the controller, the first tilt sensor including an elongated ball tube with a central longitudinal axis and a ball having a diameter less than an inner diameter of the ball tube to permit the ball to roll along the tube between opposing ends of the ball tube so as to make or break the subcircuit, the central longitudinal axis of each ball tube being pitched at an acute angle having a magnitude of at least twenty degrees with respect to a horizontal plane perpendicular to the central vertical plane and tangent to the bottom side of the main housing portion to provide a dead zone of the tilt sensor equal to or greater than the magnitude of the acute angle.

2. The toy play set of claim 1 wherein the remote control unit further comprises a second elongated handle extending longitudinally outwardly and away from the main housing portion of the housing and the first handle.

3. The toy play set of claim 2 wherein the first and second handles are configured with respect to the main housing portion of the housing so as to orient generally downwardly, palms of a user holding the first and second handles with two hands.

4. The toy play set of claim 2 wherein the central vertical plane of the remote control unit separates the first and second elongated handles from one another.

5. The toy play set of claim 2 wherein the horizontal plane of the remote control unit is tangent to a bottom side of the main housing portion of the housing, the bottom side of the main housing portion of the housing providing a base to stably support the remote control unit when not being held.

6. The toy play set of claim 2 wherein the remote control unit further comprises a switch in the housing in a subcircuit with the controller and a manual actuator exposed on the back side of the housing in operable connection with the switch.

7. The toy play set of claim 2 wherein the remote control unit further comprises a first hand lever mounted to the front side of the main housing portion of the housing extending outwardly away from the main housing portion proximal to yet spaced from and generally in line with the first handle so as to be graspable by a user together with the first handle.

8. The toy play set of claim 7 wherein the first hand lever is mounted to the main housing portion for pivotal movement and the remote control unit further comprises at least a switch in the main housing portion of the housing in a subcircuit with the controller and positioned for manual operation by pivotal movement of the first hand lever.

9. The toy play set of claim 2 wherein the first handle is mounted to the main housing portion for pivotal movement about the central longitudinal axis of the first handle and the remote control unit further comprises at least a switch in a subcircuit with the controller and positioned for actuation by pivotal movement of the first handle.

10. The toy play set of claim 2 wherein the first and second handles and the main housing portion of the housing are configured to resemble a pair of handlebars and an instrument cluster of a motorcycle and wherein the mechanized toy is a toy motorcycle

11. The toy play set of claim 2 further comprising a second tilt sensor substantially identical to the first tilt sensor, the central longitudinal axis of the ball tube of each of the first and second tilt sensors being oriented to project across the central vertical plane and each of the central longitudinal axes being pitched in opposite directions to one another at an equal acute angle of at least twenty degrees with respect to the horizontal plane perpendicular to the central vertical plane.

12. The toy play set of claim 11 wherein the mechanized toy is a toy vehicle and wherein the first and second tilt sensors are dedicated to remotely control steering of the toy vehicle.

13. The toy play set of claim 2 wherein the central longitudinal axis of the ball tube of the first tilt sensor extends toward the front and rear sides of the housing.

14. The toy play set of claim 13 wherein the mechanized toy is a toy vehicle and wherein the first tilt sensor is dedicated to remotely control a function of the toy vehicle other than steering.

15. The toy play set of claim of claim 1 wherein the first tilt sensor includes at one end of the ball tube on opposite sides of the ball tube a light source and a light responsive element aimed at the light source.

16. The toy play set of claim of claim 1 wherein the first tilt sensor includes at one end of the ball tube first and second electrically conductive members spaced apart from one another in the subcircuit with the controller and wherein the ball is electrically conductive so as to make the subcircuit in contact with the first and second electrically conductive members.

17. The toy play set of claim 1 wherein the central vertical plane of the remote control unit bisects the first handle and the main housing portion of the housing.

18. The toy play set of claim 17 wherein the housing of the remote control unit is configured to resemble a ray gun and the mechanized toy is configured as a space ship.
